(19) United States
(12) Patent Application Publication
(10) Pub. No.: US 2012/0017729 A1
(43) Pub. Date: Jan. 26, 2012

(54) WRENCH WITH ERGONOMIC TWISTED HANDLE

(76) Inventor: Chih-Min CHANG, Changhua County (TW)

(21) Appl. No.: 12/840,493

(22) Filed: Jul. 21, 2010

(51) Int. Cl. B25B 23/16; B25B 13/46

(52) U.S. Cl. 81/60; 81/177.1

(57) ABSTRACT

A wrench includes a first handle portion, a first wrench head integrally connected with the first handle portion, a second handle portion integrally connected with the first handle portion, and a second wrench head integrally connected with the second handle portion. The second handle portion is twisted about a longitudinal axis of the wrench by a predetermined angle in a range of 75-85 degrees relative to the first handle portion, such that the wrench can offer a comfortable gripping feeling to the user by the aforesaid ergonomic twisted handle design.

### BACKGROUND OF THE INVENTION

1. Field of the Invention

The present invention relates generally to a wrench, and more specifically to a wrench having an ergonomic twisted handle design so as to improve user comfort.

2. Description of the Related Art

FIG. 1 shows a conventional wrench 10, comprising a first handle portion 12, a first wrench head 14 integrally connected with the first handle portion 12, a second handle portion 16 integrally connected with the first handle portion 12, and a second wrench head 18 integrally connected with the second handle portion 16. The second handle portion 16 is twisted about a longitudinal axis of the wrench 10 by an angle of 90 degrees relative to the first handle portion 12.

According to the aforesaid design, when a user holds the first handle portion 12 to apply force to the second wrench head 18, or holds the second handle portion 16 to apply force to the first wrench head 14, the user may encounter difficulty in operation and feel discomfort upon gripping of the handle such that the user may not tighten screws or nuts firmly with the wrench 10. In other word, the conventional wrench 10 is unfit for ergonomic design and inconvenient to use.

### SUMMARY OF THE INVENTION

It is one objective of the present invention to provide a wrench, which has an ergonomic twisted handle design so as to improve user comfort and facilitation in operation.

To achieve this objective of the present invention, the wrench provided by the present invention comprises a first handle portion, a first wrench head integrally connected with the first handle portion, a second handle portion integrally connected with the first handle portion, and a second wrench head integrally connected with the second handle portion. The second handle portion is twisted about a longitudinal axis of a wrench body by a predetermined angle in a range between 75-85 degrees relative to the first handle portion so as to attain the purpose of improving user comfort and facilitation in operation.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 is a perspective view of a wrench according to a prior art;

FIG. 2 is a perspective view of a wrench according to according to a first preferred embodiment of the prevent invention;

FIG. 3 is a sectional view of the wrench according to the first preferred embodiment of the prevent invention; and

FIG. 4 is a sectional view of a wrench according to a second preferred embodiment of the prevent invention.

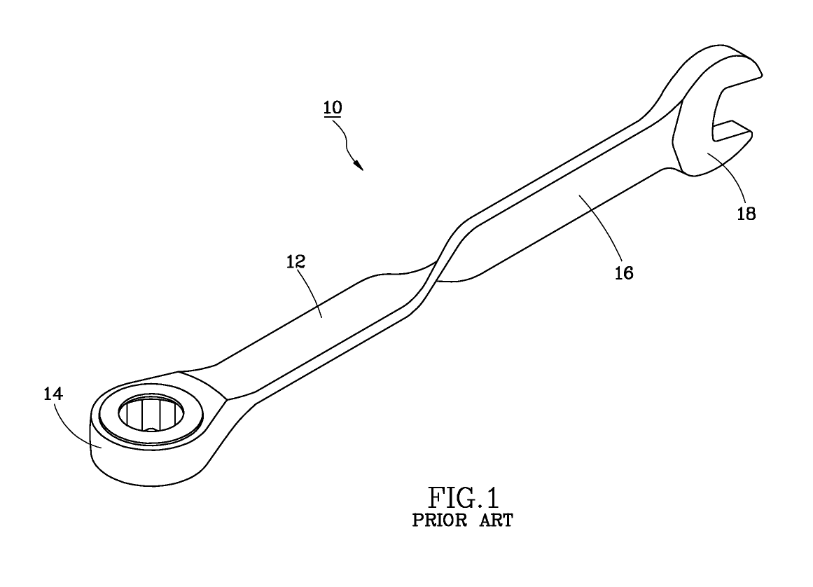

### DETAILED DESCRIPTION OF THE INVENTION

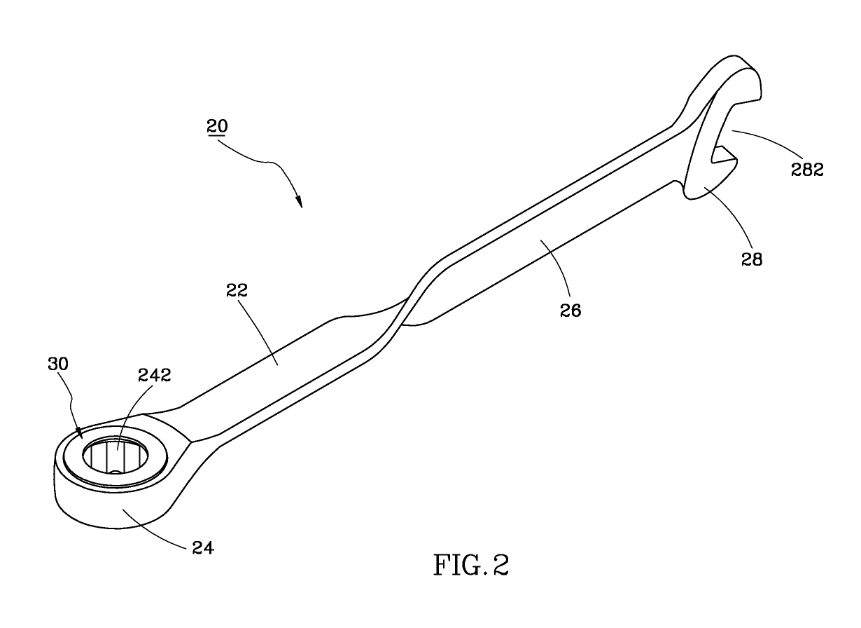

As shown in FIG. 2, a wrench 20 in accordance with a first preferred embodiment of the present invention comprises a first handle portion 22, a first wrench head 24, a second handle portion 26, and a second wrench head 28.

The first wrench head 24 is integrally connected with the first handle portion 22, and provided with a circular mounting hole 242 for installation of a racket wheel 30.

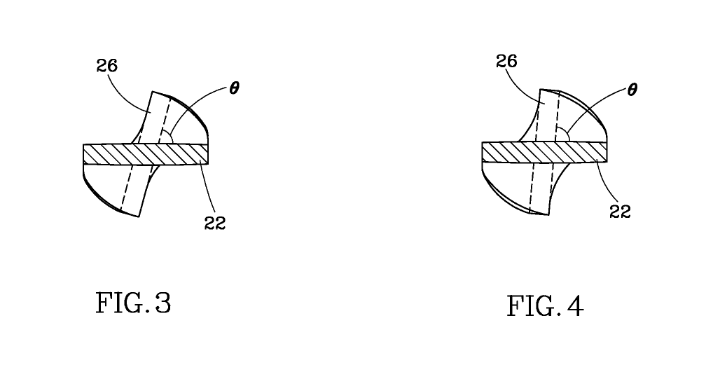

The second handle portion 26 is integrally connected with the handle portion 22, but twisted about a longitudinal axis of the body of the wrench 20 by a predetermined angle θ relative to the first handle portion 22. In this embodiment, the predetermined angle θ is 75 degrees, as shown in FIG. 3.

The second wrench head 28 is integrally connected with the second handle portion 26, and provided with a U-shaped socket 282 for engagement of a screw or nut.

By means of the aforesaid design, since a 75 degree angle is defined between the first handle portion 22 and the second handle portion 26, the wrench 20 of the present invention can fit human factors so as to improve user comfort and facilitation in operation when the user holds the first handle portion 22 or the second handle portion 26. Thus, compared with the prior art, the wrench 20 of the present invention is more ergonomic and easily employed to tighten screws or nuts, thereby attaining the purpose of the present invention.

It will be appreciated that the predetermined angle θ is not limited to 75 degrees as disclosed in the aforesaid embodiment. For example, the predetermined angle θ can be set to 85 degrees as shown in FIG. 4. In fact, the predetermined angle can be set in a range of 75 degrees to 85 degrees, achieving the same effect.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A wrench comprising:
a wrench body having a first handle portion, a first wrench head integrally connected with the first handle portion, a second handle portion integrally connected with the first handle portion, and a second wrench head integrally connected with the second handle portion;
wherein the second handle portion is twisted about a longitudinal axis of the wrench body by a predetermined angle ranging from 75 degrees to 85 degrees relative to the first handle portion.

2. The wrench as claimed in claim 1, wherein the first wrench head has a circular mounting hole, and the second wrench head has a U-shaped socket.

3. The wrench as claimed in claim 2, further comprising a ratchet wheel rotatably mounted in the circular mounting hole of the second wrench head.
